(19) United States
(12) Patent Application Publication
(10) Pub. No.: US 2025/0249621 A1
(43) Pub. Date: Aug. 7, 2025

(54) Chainsaw Guide

(71) Applicant: Philip Scott Horvath, LaPorte, IN (US)

(72) Inventor: Philip Scott Horvath, LaPorte, IN (US)

(21) Appl. No.: 19/041,798

(22) Filed: Jan. 30, 2025

Related U.S. Application Data
(60) Provisional application No. 63/549,261, filed on Feb. 2, 2024.

(51) Int. Cl. B27B 17/00; F21L 4/02; F21L 4/08; F21V 14/02; F21V 33/00

(52) U.S. Cl. CPC B27B 17/0083; F21L 4/02; F21L 4/08; F21V 14/025; F21V 33/0084

(57) ABSTRACT

The chainsaw guide includes a guide head having two independent spherical “eyes” that each support a light emitter. The spherical eyes can be manually adjusted within the guide head to space the visible light markers projected onto a work piece from the light emitters at select distances and orientation from one another. The guide head houses the internal electrical circuitry to activate and control the light emitters. The chainsaw guide is powered by a remote battery pack.

This application claims the benefit of U.S. Provisional Patent Application, Ser. No. 63/549,261 filed Feb. 2, 2024, the disclosure of which is hereby incorporated by reference.

This invention relates to chainsaws and in particular a cutting guide for chainsaws to facilitate accurate repeated cutting of work pieces to a specified length.

### BACKGROUND AND SUMMARY OF THE INVENTION

When cutting logs for firewood, it is desirable to consistently cut log sections to the same length. A variety of rigid cutting stops have been developed for this purpose. Other cutting guides use a laser or other light emitter aligned with the cutting plane of the chainsaw to indicate where a cut will be made.

The chainsaw guide of this invention allows a user to quickly visually gauge the desired length of work pieces being cut, by projecting a visible light beams onto a work piece from an adjustable spherical “eye.” The chainsaw guide includes a guide head that detachably mounts to the hand guard/brake of a conventional chainsaw. The guide head includes one or more spherical “eyes” that internally house a light emitter. The spherical eyes can be manually adjusted within the guide head to space the visible light beam projected onto a work piece at select distances from one another. The chainsaw guide includes internal electrical circuitry to activate and control the light emitters. The chainsaw guide is powered by a remote battery pack.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the chainsaw guide of this invention, mounted to a conventional chainsaw;

FIG. 2 is a top view of the chainsaw guide of FIG. 1 mounted to a conventional chainsaw;

FIG. 3 is a front perspective view of the chainsaw guide of FIG. 1;

FIG. 4 is a rear perspective view of the chainsaw guide of FIG. 1;

FIG. 5 is a bottom perspective view of the head unit of the chainsaw guide of FIG. 1;

FIG. 6 is a bottom view of the head unit of the chainsaw guide of FIG. 1; and

FIG. 7 is a perspective view of a second embodiment of the chainsaw guide of this invention.

### DESCRIPTION OF THE PREFERRED EMBODIMENT

In the following detailed description of the preferred embodiments, reference is made to the accompanying drawings that form a part hereof, and in which is shown byway of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The chainsaw guide of this invention is designed and intended for use with conventional chainsaws. The chainsaw guide allows a user to quickly visually gauge the desired length of work pieces being cut, by projecting two visible laser marks onto a work piece from two separate adjustable laser emitters. The chainsaw guide includes a guide head that detachably mounts to the hand guard/brake of a conventional chainsaw. The guide head adjustably supports two spherical “eyes” that house at least one light or laser beam emitter. The light emitters project visible beams of light from the eyes onto a work piece. Each eye can be manually adjusted and positioned to align the light beams at select distances and orientations relative to one another and the chain bar of the chainsaw. The chainsaw guide includes internal electrical wiring and circuitry to activate and control the light emitters. The chainsaw guide is generally powered by a DC current from internal batteries or remote battery packs. The batteries and battery packs may take a variety of conventional design using either recharagable or non-rechargable type batteries. In certain embodiments, the guide may be powered from external power supplies, such as AC outlets via external power cables. In other embodiments used with electric chainsaws, the chainsaw's own electrical systems may be used to power the chainsaw guide.

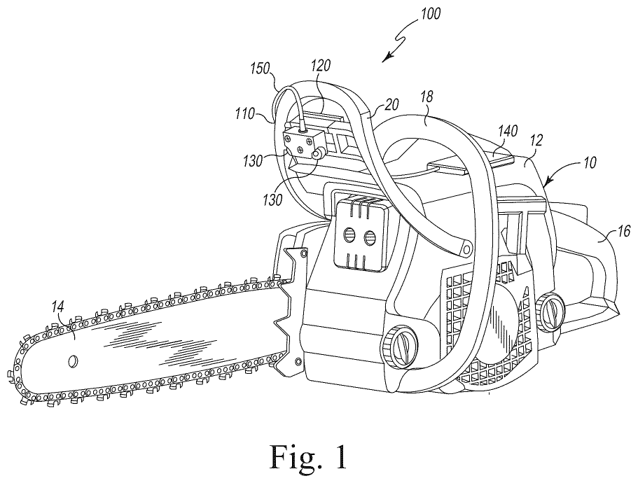

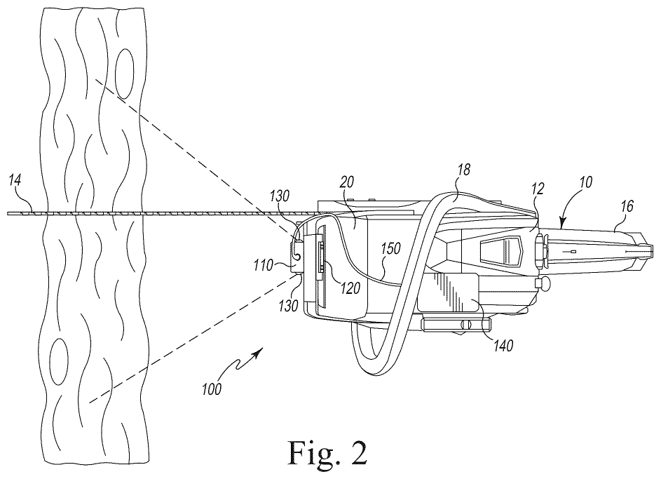

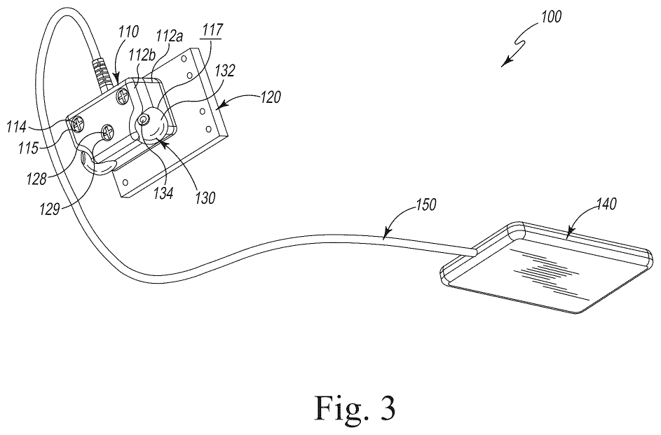

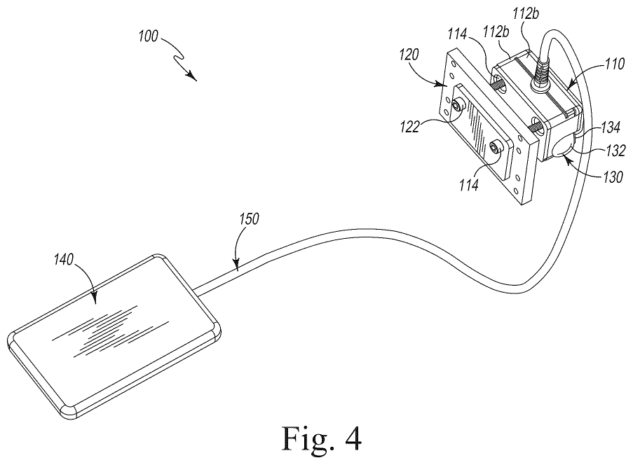

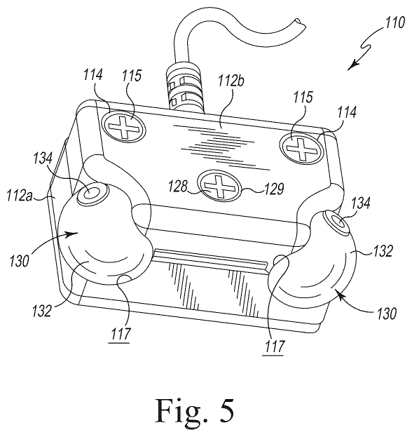

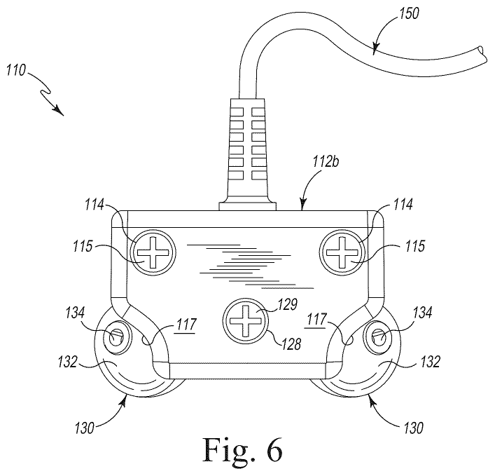

Referring now to the drawings, FIGS. 1-6 illustrate an exemplary embodiment of the chainsaw guide, which is designated generally as reference numeral 100. Chainsaw guide 100 is illustrated mounted to a convention chainsaw, such as those manufactured and sold by Stihl, Incorporated, although the guide may be adapted for use on any chainsaw or cutting devices within the teachings of this invention. As shown, chainsaw 10 is of convention design and function and includes a motor housing 12, a chain bar 14 extending from the motor housing, a rear handle 16, a front handle 18, and a hand guard/brake 20 pivotally mounted to the motor housing forward of the front handle.

Chainsaw guide 100 uses a two piece design and includes a guide head 110 mounted directly to the guard/brake 20 and a remote battery pack 140 secured to the motor housing 12. Guide head 110 includes a guide head housing 112 and a pair of independently adjustable “eyes” 130, each supporting an internal light emitter 134. Light emitters 134 are powered by battery pack 140 via a detachable power cable 150 connecting guide head 110 to the battery pack. Battery pack 140 is a rechargable battery and may include a recharging port (not shown). A flat backing plate 120 secures guide head 110 to guard/brake 20 using a pair of mounting bolts 122 that thread into threaded inserts 114 from the rear of the guide head. Backing plate 120 and fasteners 122 mounting mechanism allows guide head 110 to be mounted and position on guard/brake 20 of most conventional chainsaws, regardless of the style or configuration of the guard/brake.

Light emitters 134 are of conventional design and function and generally consists of a light emitting diode (not shown), focused light emitter, laser, or other similar type of light projecting device. Guide head housing 112 supports and encloses the electrical wiring circuitry that controls and powers the light emitter 134 in each adjustable eye 130. Chainsaw guide 100 employs conventional electrical wiring and circuitry of type commonly used to power and control light emitters 134. This electronic circuitry includes an on/off power switch (now shown) and other controls to adjust the intensity (brightness) of the light beam projected from light emitters 134.

Guide head housing 112 use a two piece housing design formed by front and rear housing sections 112a and 112b. Front and rear housing sections 112a and 112b are secured together by two fastener screws 115 turned into threaded inserts 114 molded into the housing sections. Each eye 130 includes an internal electronic light emitter 134 disposed within a spherical eye body 132. Each light emitter 134 projects a visible beam of light from eye 130. Ideally, light emitters 134 projects a beam of light so that a visible marker is illuminated onto a work piece from guide head 110 from each eye 130. Light emitters 134 also produce the light beam within the color spectrum ranging through red, green and violet. Each eye body 132 is rotatably seated within a rounded socket 117 formed between front and rear housing sections 112a and 112b on either side of guide head 110. A central tension screw 129 is turned into a threaded insert 128 molded between housing sections 112a and 112b. Tension screw 128 can be loosened and tightened to manually rotate and orient each eye 130 within socket 117 relative to guide head 110 to separately adjust and orient the light beams projected from light emitters 134 onto the work piece. Each eye 130 can be manually adjusted and positioned relative to guide head 110 to independently position the visible marker illuminated onto a work piece from the light beams projected from each light emitter at user defined spaced distances and orientations. Eyes 130 can also be independently adjusted and positioned to project the light beams on either side of chain bar 14 as necessary.

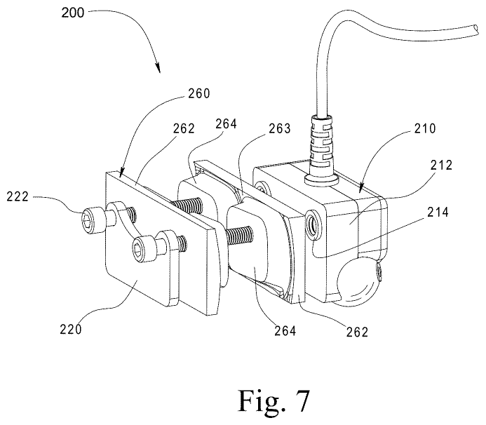

In other exemplary embodiments of the chainsaw guide of this invention, the backing plate may be modified and adapted for use with any particular brand or model of chainsaw. FIG. 7 illustrates another exemplary chainsaw guide of this invention, designated as references numeral 200, which includes a backing plate 220 and two-piece backing insert assembly 260 for mounting guide head 210 to a conventional chain brake (not shown). As shown, backing insert assembly 260 includes a pair of opposed backing inserts 262. Each backing insert 262 has a contoured opposed face 263 with two raised projections 264. Raise projections 264 are shaped and contoured to mate in and against specific contoured cavities formed in the chain brake of the particular brand and model of chain saw. Again, backing plate 240 and backing inserts 262 are held together with the chain brake securely interposed between the plates by mounting bolts 222 that thread into threaded inserts 214 and guide head housing 212 (not labeled on FIG. 7). The use of backing inserts assembly 260, allows different inserts 262 to be readily replaced and swapped out to accommodate the configuration of different brands and models of chainsaws.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A cutting guide for a chainsaw including a motor housing, a chain bar extending from the motor housing and a guard/brake mounted to the motor housing, the guide comprising:
guide head adapted to detachably mount to the guard/brake;
a pair of spherical eyes adjustably seated on the guide head to be independently and selectively oriented relative to one another; and
a light emitter disposed within each of the pair of spherical eyes for independently projecting a light beam onto a work piece to be cut by the chainsaw.

3. The chainsaw guide of claim 1 wherein the guide head includes a first housing section and a second housing section, each of the pair of spherical eyes being restrictively seated between the first housing section and the second housing section and selectively oriented with respect to one another so that the light beam from the light emitter of each of the pair of spherical eyes is spaced and oriented at a select distance from one another.

4. The chainsaw guide of claim 1 and a remote power supply adapted to detachably mount to the chainsaw.

5. The chainsaw guide of claim 4 wherein the remote power supply operatively connected to the guide head by an electrical cable.

6. The chainsaw guide of claim 1 wherein the guide head includes a backing plate for securing the guide head to the guard/brake of the chainsaw.

7. The chainsaw guide of claim 1 wherein the guide head includes a tension device for selectively securing and orienting the pair of spherical eyes between the first housing section and second housing section.

8. The chainsaw guide of claim 6 wherein the guide head further includes a a pair of opposed backing inserts, each of the pair of opposed backing inserts has a contoured opposed face with a raised projection shaped and contoured to mate in and against the guard/brake of the chain saw.
